(19) United States
(12) Patent Application Publication
(10) Pub. No.: US 2021/0303543 A1
(43) Pub. Date: Sep. 30, 2021

(54) MESSAGE INFORMATION MANAGEMENT SYSTEM, MESSAGE INFORMATION MANAGEMENT METHOD, MESSAGE INFORMATION MANAGEMENT DEVICE, AND MESSAGE INFORMATION MANAGEMENT PROGRAM

(71) Applicant: Nippon Telegraph and Telephone Corporation, Tokyo (JP)

(72) Inventors: Yuki AKAMATSU, Tokyo (JP); Noritaka HORIKOME, Tokyo (JP); Ikuo OTANI, Tokyo (JP)

(21) Appl. No.: 17/266,263

(22) PCT Filed: Jul. 25, 2019
(86) PCT No.: PCT/JP2019/029145

§ 371 Date: Feb. 5, 2021

(30) Foreign Application Priority Data
Aug. 9, 2018 (JP) 2018-150116

(51) Int. Cl. G06F 16/23; G06F 16/27; H04L 9/32; H04M 3/51

(52) U.S. Cl. CPC G06F 16/2308; H04M 3/5116; H04L 9/3265; G06F 16/27

(57) ABSTRACT

[Problem] Even when the operator to which the user to be referred belongs is unknown, message information can be referred by making an inquiry to a message board service of one operator.

[Solution] A message information management apparatus 10 of a message information management system 1000 includes: a registration request reception unit 11 that receives a message information registration request; a transaction confirmation unit 13 that confirms the normality of message information; a transaction issuance unit 12 that issues a transaction including the message information; a block approval unit 15 that confirms the normality of the proposed block; a block generation unit 14 that generate a newly proposed block including one or more transactions, registers the newly proposed block as a new block in a blockchain stored in an own storage unit, and causes the other message information management apparatuses to register the new block; and a message information search unit 16 that receives a message information reference request, searches each block stored in the own storage unit and reply the message information.

### TECHNICAL FIELD

The present invention relates to a message information management system, a message information management method, a message information management apparatus, and a message information management program that manage the message information of a disaster message board service.

### BACKGROUND ART

The disaster message board service is a dedicated service for disaster configured such that when a large disaster occurs, a person in a disaster area (registered user) can register his or her safety from the PC, mobile phone, smartphone, or the like as message information (text information), and anyone (referring user) can confirm the registered message information via the Internet or the like (see Non Patent Literature 1).

The registered user can register the message information only with a disaster message board service (hereinafter, may be referred to as a “message board service”) offered by the operator (the communication service operator) to which the registered user belongs. For example, as illustrated in FIG. 9, the registered user of a company A (the registered user terminal 21 of the company A) can register message information with a message board service 91 of the company A. However, the registered user of the company A (the registered user terminal 21 of the company A) cannot register message information with a message service 92 of a company B.

In addition, when a certain referring user (a referring user terminal 35 of the user who refers to message information from the message board service) refers to message information, the referring user cannot obtain the message information without accessing the message board service of the operator to which the registered user to be referred belongs. That is, when the operator to which the user to be referred belongs is unknown, the referring user (the referring user terminal 35) needs to access each of message board services offered by operators.

In this regard, there is also a service that executes as a proxy for search for message information (multi-company message reception service 95) (see Non Patent Literature 2). In the multi-company message reception service 95, the message information to be referred can be searched from among message information stored in the message board services offered by the operators.

For example, as illustrated in FIG. 10, when the referring user (the referring user terminal 35) requests the multi-company message reception service 95 to refer to message information, the multi-company message reception service 95 refers to each of the message board services of the operators to search for the message information, and transmits the message information acquired by the search to the referring user.

### CITATION LIST

### Non Patent Literature

Non Patent Literature 1: “Outline of Disaster Message Board (web171) and Mechanism of Provision”, [online], Nippon Telegraph and Telephone East Corporation, [Searched on Aug. 3, 2018], Internet <URL: https://www.ntt-east.co.jp/saigai/web171s/shikumi.html>
Non Patent Literature 2: “J-anpi”, [online], NTT Resonant Incorporated, [Searched on Aug. 3, 2018], internet URL: https://anpi.jp/info/disclaimer.html

### SUMMARY OF THE INVENTION

### Technical Problem

However, in the present situation, as described above, when the operator to which the user to be referred belongs is unknown, the referring user cannot refer to the message information of the target registered user without making an inquiry to each of the message board services offered by the operators.

If the number of operators that offer such disaster message board service will increase in the future, as illustrated in FIG. 11, the referring user (the referring user terminal 35) and the multi-company message reception service 95 may require more time and processing troubles (man-hours) to search the message board services (91, 92, 93, . . . ) of the operators and refer to the message information.

The present invention is devised in view of such background, and an object of the present invention is to provide a message information management system, a message information management method, a message information management apparatus, and a message information management program that can refer to message information by making an inquiry to a message board service of one operator even when the operator to which the user to be referred belongs is unknown.

### Means for Solving the Problem

In order to attain the above-mentioned object, the invention of first aspects provides a message information management system having a plurality of message information management apparatuses configured to offer a message board service for registering and referring to message information, the plurality of message information management apparatuses being communicatively connected to each other to constitute a blockchain system, wherein each of the plurality of message information management apparatuses includes: a registration request reception unit configured to receive a message information registration request with the message information; a transaction issuance unit configured to transmit a message information normality confirmation request requesting normality confirmation of the message information to a transaction confirmation unit and issue a transaction including the message information when normality of the message information is confirmed by acquiring a message information normality confirmation notification; the transaction confirmation unit configured to receive the message information normality confirmation request, and when the normality of the message information is confirmed, transmit the message information normality confirmation notification to the transaction issuance unit; a block generation unit configured to acquire the issued transaction, generate a newly proposed block including one or more transactions, transmitting a block approval request with the generated proposed block to block approval units of the own and other message information management apparatuses, and when normality of the proposed block is confirmed by acquiring a block approval notification, register the proposed block as a new block in a blockchain stored in an own storage unit, transmit a message information writing request to the other message information management apparatuses, and cause the other message information management apparatuses register the proposed block as a new block in blockchains stored in storage units of the other message information management apparatuses; the block approval unit configured to receive the block approval request, and when the normality of the proposed block is confirmed, transmit the block approval notification to the block generation unit; and a message information search unit configured to receive a message information reference request requesting reference to the registered message information, search each block in the blockchain stored in the own storage unit, and reply the message information acquired by the search.

The invention of third aspect provides a message information management method for a message information management system having a plurality of message information management apparatuses configured to offer a message board service for registering and referring to message information, the plurality of message information management apparatuses being communicatively connected to each other to constitute a blockchain system, the method including, at each the message information management apparatuses: receiving a message information registration request with the message information; confirming normality of the message information; issuing a transaction including the message information when the normality of the message information is confirmed; acquiring the issued transaction and generating a newly proposed block including one or more transactions; transmitting a block approval request with the generated proposed block to the own and other message information management apparatuses and confirming the normality of the proposed block by acquiring a block approval notification; when the normality of the proposed block is confirmed, registering the proposed block as a new block in a blockchain stored in an own storage unit, transmitting a message information writing request to the other message information management apparatuses, and causing the other message information management apparatuses to register the proposed block as a new block in blockchains stored in storage units of the other message information management apparatuses; and receiving a message information reference request requesting reference to the registered message information, searching each block in the blockchain stored in the own storage unit, and replying the message information acquired by the search.

The invention of fourth aspect provides a message information management apparatus in a message information management system having a plurality of message information management apparatuses configured to offer a message board service for registering and referring to message information, the plurality of message information management apparatuses being communicatively connected to each other to constitute a blockchain system, the message information management apparatus including: a registration request reception unit configured to receive a message information registration request with the message information; a transaction issuance unit configured to transmit a message information normality confirmation request requesting normality confirmation of the message information to a transaction confirmation unit and issue a transaction including the message information when the normality of the message information is confirmed by acquiring a message information normality confirmation notification; a transaction confirmation unit configured to receive the message information normality confirmation request, and when the normality of the message information is confirmed, transmit the message information normality confirmation notification to the transaction issuance unit; a block generation unit configured to acquire the issued transaction, generate a newly proposed block including one or more transactions, transmit a block approval request with the generated proposed block to block approval units of the own and other message information management apparatuses, and when normality of the proposed block is confirmed by acquiring a block approval notification, register the proposed block as a new block in a blockchain stored in an own storage unit, transmit a message information writing request to the other message information management apparatuses, and cause the other message information management apparatuses to register the proposed block as a new block in blockchains stored in storage units of the other message information management apparatuses; the block approval unit configured to receive the block approval request, and when the normality of the proposed block is confirmed, transmit the block approval notification to the block generation unit; and a message information search unit configured to receive a message information reference request requesting reference to the registered message information, search each block in the blockchain stored in the own storage unit, and reply the message information acquired by the search.

In this way, all message information is stored as blockchains in each of the message information management apparatuses. Thus, the user referring to the message information can refer to the registered message information even when transmitting the message information reference request to any message information management apparatus.

The invention of second aspect provides the message information management system according to the invention of the first aspect, wherein the transaction issuance unit configured to issue a transaction including a message information confirmed notification information indicating that the normality of the message information is confirmed in addition to the message information, and

the block approval unit is configured to confirm that the proposed block is normal when each of one or more transactions of the proposed block includes the message information confirmed notification information.

By using the transaction including the message information confirmed notification information to verify the normality, the block can be approved more easily while ensuring the normality of the block. Thus, processing loads of the block approval can be reduced to reduce processing time.

The invention of fifth aspect provides a message information management program for causing a computer to function as the message information management apparatus according to the invention of the fourth aspect.

In this manner, each function of the message information management apparatus according to the invention of the fourth aspect can be implemented by using a general-purpose computer.

### Effects of the Invention

The present invention can provide a message information management system, a message information management method, a message information management apparatus, and a message information management program that can refer to message information by making an inquiry to a message board service of one operator even when the operator to which the user to be referred belongs is not known.

### BRIEF DESCRIPTION OF DRAWINGS

FIG. 1 is a diagram illustrating an overall configuration of a message information management system according to the present embodiment.

FIG. 2 is a diagram illustrating blocks stored in a message information storage DB in a blockchain according to the present embodiment.

FIG. 3 is a sequence diagram illustrating a flow of message information registration processing executed by the message information management system according to the present embodiment.

FIG. 4 is a sequence diagram illustrating a flow of the message information registration processing executed by the message information management system according to the present embodiment.

FIG. 5 is a sequence diagram illustrating a flow of message information reference processing executed by the message information management system according to the present embodiment.

FIG. 6 is a diagram illustrating blocks of blockchains stored in a message information storage DB according to a modification example of the present embodiment.

FIG. 7 is a sequence diagram illustrating a flow of message information registration processing executed by a message information management system according to a modification example of the present embodiment.

FIG. 8 is a sequence diagram illustrating a flow of the message information registration processing executed by the message information management system according to a modification example of the present embodiment.

FIG. 9 is a diagram illustrating reference to message information in a disaster message board service in the related art.

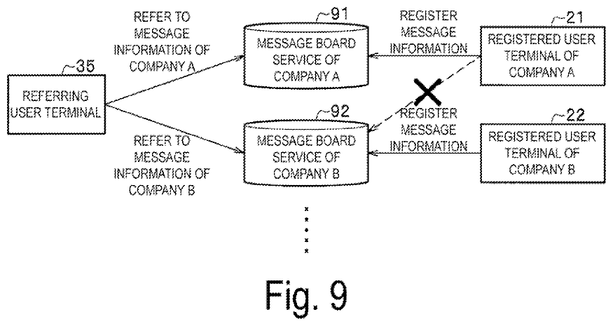

FIG. 10 is a diagram illustrating reference to message information in a disaster message board service (multi-company message reception service) in the related art.

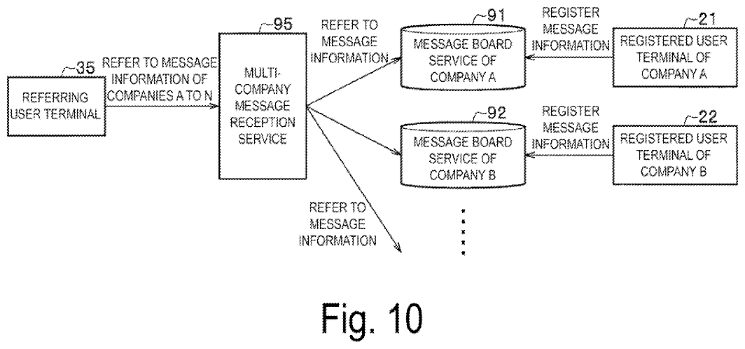

FIG. 11 is a diagram illustrating a problem in reference to a disaster message board service in the related art.

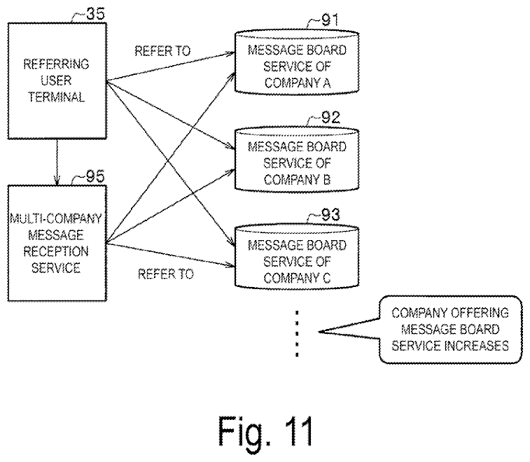

### DESCRIPTION OF EMBODIMENTS

A message information management system 1000 and so on in an embodiment for carrying out the present invention (hereinafter referred to as the present embodiment) will be described below.

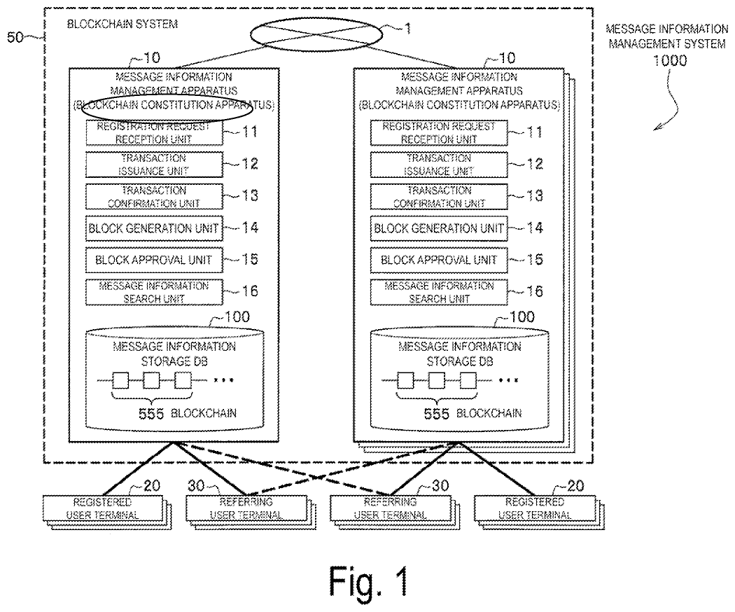

FIG. 1 is a diagram illustrating an overall configuration of the message information management system 1000 according to the present embodiment.

As illustrated in FIG. 1, the message information management system 1000 is constituted of a blockchain system 50 that includes a plurality of message information management apparatuses 10 (blockchain constitution apparatuses) connected to each other via a peer-to-peer (P2P) network 1. Further, each of the message information management apparatuses 10 is connected to a terminal (registered user terminal 20) of a user (registered user) belonging to a communication service offered by each operator, and a terminal (referring user terminal 30) of a user (referring user) referring to message information registered with the disaster message board service.

In the message information management system 1000 according to the present embodiment, the message information management apparatus 10 receives a registration request of the message information (text information), which is safety information about disaster, from the registered user terminal 20. Then, the message information management apparatus 10 generates a block including the message information, and stores the generated block as a new block in each of the message information management apparatuses 10 configuring the blockchain system 50, thereby registering the message information. As a result, the message information of all operators is stored as a blockchain in the message information management apparatus 10 of each operator. Thus, the user referring to message information (the referring user terminal 30) can refer to the message information of the registered user by making an inquiry to the message information management apparatus 10 of any operator.

Message Information Management Apparatus

Next, the message information management apparatus 10 according to the present embodiment will be described.

The message information management apparatus 10 is an apparatus with which each operator offers a disaster message board service to users belonging to its own communication service, and is installed for each operator. The message information management apparatus 10 is also a blockchain constitution apparatus that manages message information received from the registered user terminal 20 as a blockchain.

The message information management apparatus 10 is connected to another message information management apparatus 10 that participates in the blockchain system 50, as well as the registered user terminal 20 requesting the registration of the message information with the message board service, and the referring user terminal 30 requesting the reference to the registered message information.

The registered user terminal 20 and the referring user terminal 30 each are configured of a general computer (PC, tablet, smartphone, or the like) including a control unit, an input/output unit, and a storage unit (all not illustrated), and connected to each of the message information management apparatuses 10 via a network such as the Internet.

In the present embodiment, the message information management apparatus 10 participating in the blockchain system 50 is based on a Permissioned-type blockchain in which services using the blockchain are used by limited members, rather than a public blockchain in which anyone can participate, such as a blockchain used in financial transactions.

Since the plurality of message information management apparatuses 10 participating in the blockchain system 50 have the identical function, one message information management apparatus 10 will be described.

The message information management apparatus 10 includes a control unit, an input/output unit, and a storage unit (none of which are illustrated).

The input/output unit is configured of a communication interface that transmits/receives information to/from another message information management apparatus 10, or the registered user terminal 30 or the referring user terminal 20 that is connected to the own message information management apparatus 10.

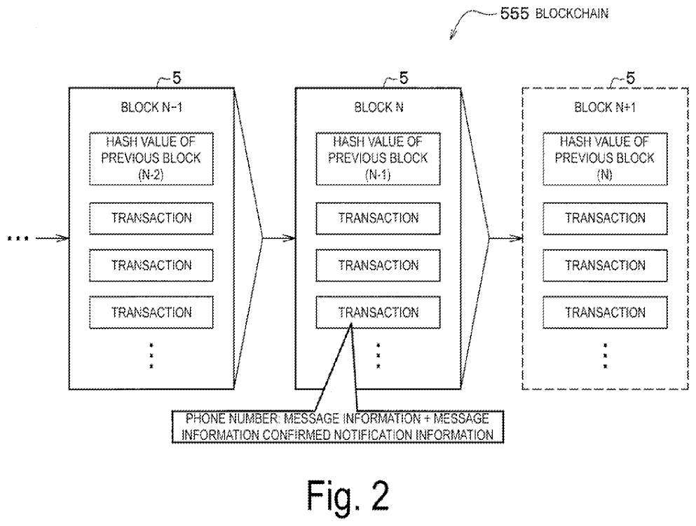

The storage unit is configured of a hard disk, a flash memory, a random access memory (RAM), or the like. The storage unit stores a message information storage DB (database) 100 that stores the block 5 including the message information as a blockchain 555 (which is described below, see FIG. 2). The storage unit also stores a program (message information management program) for executing each function of the control unit.

As illustrated in FIG. 1, the control unit includes a registration request reception unit 11, a transaction issuance unit 12, a transaction confirmation unit 13, a block generation unit 14, a block approval unit 15, and a message information search unit 16. The control unit is realized by, for example, causing a Central Processing Unit (CPU) (not illustrated) to load the program (message information management program) stored in the storage unit into a RAM and execute the program.

The registration request reception unit 11 receives a request to register the message information with the message board service (message information registration request) from the registered user terminal 20 via the input/output unit. Then, the registration request reception unit 11 outputs the received message information registration request to the transaction issuance unit 12. The message information (text information for confirmation of security) associated with a telephone number registered with the communication service of the operator is added to the message information registration request.

Note that upon reception of the message information registration request, the registration request reception unit 11 may inquire a subscriber authentication server not illustrated to determine whether or not the user who transmits the message information registration request belongs to its own communication service. This can prevent the registration of fraudulent message information such as spoofing.

When receiving the message information registration request, to confirm the normality of the message information, the transaction issuance unit 12 outputs a message information normality confirmation request to the transaction confirmation unit 13.

Specifically, the transaction issuance unit 12 outputs the message information normality confirmation request to the transaction confirmation unit 13 of the message information management apparatus 10 of the own operator, and transmits the message information normality confirmation request to the transaction confirmation unit 13 of the message information management apparatus 10 of each of the other operators. Then, when receiving an approval of the normality confirmation (message information normality confirmation notification) from 50% or more of the transaction confirmation units 13, the transaction issuance unit 12 determines that the normality of the message information is confirmed. Note that the criteria for determining that confirmation is completed at this time may be any number (or any percentage) other than the majority.

In addition, the transaction issuance unit 12 may output the message information normality confirmation request to only the transaction confirmation unit 13 of the message information management apparatus 10 of the own operator, and may complete the confirmation of the normality of the message information when the transaction confirmation unit 13 of the own apparatus has confirmed the normality.

The method for determining the completion of the normality confirmation is previously set by an administrator or the like of the message information management system 1000. Hereinafter, in the present embodiment, a determination is made that the normality confirmation of the message information is completed when the approval of the normality confirmation (message information normality confirmation notification) is acquired from 50% or more of the transaction confirmation units 13 including the transaction confirmation units 13 of the other operators.

In accordance with a determination that the normality confirmation of the message information is completed, the transaction issuance unit 12 issues a transaction (see FIG. 2) including the message information associated with the telephone number and the “message information confirmed notification information” indicating that the message information normality confirmation is completed. Then, the transaction issuance unit 12 outputs the issued transaction to the block generation unit 14 of the message information management apparatus 10 of the own operator or to the block generation units 14 of the message information management apparatuses 10 of the other operators. Which of the block generation units 14 of the message information management apparatuses 10 generates the block is previously set by the administrator or the like of the message information management system 1000. Hereinafter, in the present embodiment, the transaction issued by the transaction issuance unit 12 is output to the block generation unit 14 of the message information management apparatus 10 of the own operator that receives the message information from the registered user terminal 20 (that is, is caused the block generation unit 14 of the own operator to generate the block).

The transaction confirmation unit 13 receives the message information normality confirmation request from the transaction issuance unit 12 of the own operator or the other operators, and confirms the normality of the message information. In confirmation of the normality of the message information, it is confirmed whether or not an improper character string (for example, characters of a non-corresponding language, etc.) is included in the message information (text information).

When confirming the normality of the message information (approving the normality confirmation), the transaction confirmation unit 13 transmits the message information normality confirmation notification to the transaction confirmation unit 13 that transmits the message information normality confirmation request.

The block generation unit 14 receives the transaction from the transaction issuance unit 12 of the own operator or the other operators and generates a block 5 including one or more transactions. This block 5 includes one or more transactions and a hash value (“hash value of a previous block” described later) calculated using all transactions (one or more transactions) included in the current block among the blocks 5 stored as the blockchain 555 in the message information storage DB 100.

Note that any number of one or more of the transactions stored in the block may be set by an administrator or the like of the message information management system 1000.

FIG. 2 is a diagram illustrating the blocks 5 stored as the blockchain 555 in the message information storage DB 100 of each message information management apparatus 10.

Each block 5 includes information about one or more transactions (hereinafter may be referred to as “transaction group”) and information about the “hash value of the previous block”. In the example illustrated in FIG. 2, a current block N at the present (connected last) stores a hash value (hash value of the previous block (N−1)) calculated for a transaction group in a block N−1 connected last and a hash value of the previous block (N−2) using a hash function, and information about the current transaction group at present.

When generating a proposed block 5, the block generation unit 14 calculates a hash value for the transaction group in the current block (block N) and the hash value of the previous block (N−1) using the hash function. Then, the block generation unit 14 generates a block 5 including the calculated hash value (the hash value of the previous block (N)) and the newly aggregated transaction group, as the proposed block (block N+1).

Note that the message information management apparatus 10 that generates the proposed block is basically fixed to one operator. However, the block generation units 14 of the message information management apparatuses 10 of the operators may generate the block in turn.

In addition, when one block is generated for one transaction, the block generation unit 14 of the message information management apparatus 10 to which the transaction issuance unit 12 that issues the transaction belongs may generate the block.

When generating the newly proposed block 5 (block N+1), the block generation unit 14 outputs a block approval request including the proposed block N+1 to the block approval unit 15 of the message information management apparatus 10 of the own operator, as well as the block approval unit 15 of the message information management apparatus 10 of each of the other operators. Then, when receiving the approval of the block (block approval notification) from 50% or more of block approval units 15, the block generation unit 14 determines that the approval of the block is completed. Note that the criteria for determining that the approval of the block is completed may be any number (or any percentage) other than majority. The method for determining the completion of the block approval is previously set by an administrator or the like of the message information management system 1000. Hereinafter, in the present embodiment, it is determined that the block approval is completed when a block approval (block approval notification) is acquired from 50% or more of the block approval units 15.

In accordance with a determination that the completion of the block approval, the block generation unit 14 writes the message information into the message information storage DB 100 of the message information management apparatus 10 of the own operator (adds the block), and transmits a message information writing request to the block generation units 14 of the message information management apparatuses 10 of the other operators. The block generation units 14 of the other operators that receives the message information writing request writes the message information into the message information storage DB 100 (adds the block). As a result, a new block 5 is connected to the block N and stored as a next block (block N+1) in the blockchain 555 stored in the message information storage DB 100 of each of the message information management apparatuses 10.

The block generation unit 14 of each of the message information management apparatus 10 constituting the blockchain stores the new block 5 (block N+1) in the message information storage DB 100, such that the identical transaction (message information) is stored in all of the message information management apparatuses 10.

When receiving the block approval request from the block generation unit 14 of the own operator or other operators, the block approval unit 15 verifies the normality of the block (block N+1) added to the block approval request.

The verification of the normality, for example, is performed as follows. For the current block (block N) in the blockchain 555 stored in the message information storage DB 100 of the message information management apparatus 10 (see FIG. 2), the block approval unit 15 calculates a hash value by using one or more transactions (transaction group) and the hash value of the previous block (N−1). The block approval unit 15 determines whether or not the hash value of the previous block included in the block N+1 newly proposed in the block approval request matches the calculated hash value. When the hash values match, the block approval unit 15 approves the block as a normal block, and transmits the block approval notification to the block generation unit 14 of the own operator or the other operators that has transmitted the block approval request.

Note that the block approval unit 15 may verify the normality of the proposed block in other ways. For example, for the block (block N+1) added to the block approval request, the block approval unit 15 confirms whether or not the message information confirmed notification information is included each of one or more transactions in the proposed block N+1. Then, when the message information confirmed notification information is included in all of the transactions, the block approval unit 15 approves the block as a normal block. By using the message information confirmed notification information to verify the normality in this way, the block can be approved more easily while ensuring the normality of the block, thereby reducing processing loads on the block approval to shorten processing time.

The normality verification method performed by the block generation unit 14 is previously set by the administrator or the like of the message information management system 1000.

The message information search unit 16 receives a message information reference request of the disaster message board service from the referring user terminal 30 via the input/output unit. Then, the message information search unit 16 searches for the message information from the block 5 stored in the message information storage DB 100 by using the phone number added to the received message information reference request as a key. Since two or more pieces of message information with the identical phone number may be stored in the blockchain 555, the message information search unit 16 extracts more recent message information as message information to be read. Then, the message information search unit 16 generates a message information reference reply with the searched message information, and notifies the message information reference reply to the referring user terminal 30 that has transmitted the message information reference request.

Note that in the message information management apparatus 10, a database (DB) that stores only the current message information may be prepared in addition to the message information storage DB 100 that stores the blockchain 555, and the message information search unit 16 may search the database such that loads on the search and reading of the message information are distributed. In this manner, the message information can be performed faster (smoothly).

The message information search unit 16 searches for the message information from the message information storage DB 100 that stores the message information of the user belonging to the own operator as well as the message information of all operators as the blockchain 555. Thus, even when the operator to which the user to be referred belongs is unknown, the referring user terminal 30 can refer to the message information by transmitting the message information reference request to the message information management apparatus 10 of any operator.

Processing of Message Information Management System Next, as processing executed by the message information management system 1000 according to the present embodiment, (1) message information registration processing in which the message information management apparatus 10 registers the message information received from the registered user terminal 20 with the blockchain, (2) message information reference process in which the message information management apparatus 10 receives the reference request from the referring user terminal 30 and searches for the message information from the blockchain and allowing the referring user terminal 30 to refer to the message information will be described.

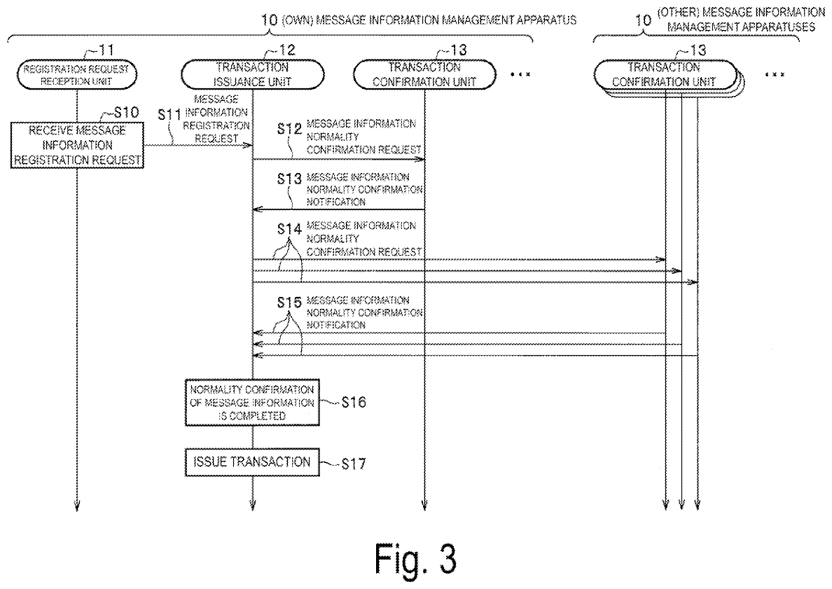

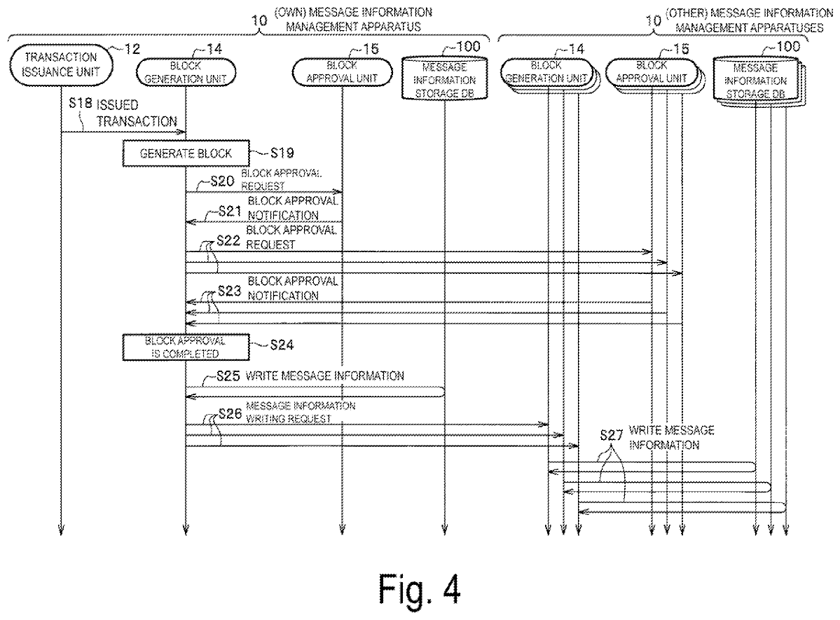

Message Information Registration Processing FIGS. 3 and 4 are sequence diagrams illustrating a flow of the message information registration processing executed by the message information management system 1000 according to the present embodiment.

In FIG. 3, first, the registration request reception unit 11 of the message information management apparatus 10 receives the message information registration request with the message board service from the registered user terminal 20 (step S10).

Then, the registration request reception unit 11 outputs the received message information registration request to the transaction issuance unit 12 (step S11).

To confirm the normality of the message information, the transaction issuance unit 12 outputs the message information normality confirmation request to the transaction confirmation unit 13 of the message information management apparatus 10 of the own operator (step S12). Then, the transaction issuance unit 12 acquires the message information normality confirmation notification indicating that the approval of the normality confirmation is acquired, from the transaction confirmation unit 13 (step S13).

In addition, the transaction issuance unit 12 transmits the message information normality confirmation request to the transaction confirmation unit 13 of the message information management apparatus 10 of each of the other operators (step S14). Then, the transaction issuance unit 12 receives the message information normality confirmation notification indicating that the approval of the normality confirmation is acquired, from the transaction confirmation units 13 of the other operators (step S15).

Here, when receiving an approval of the normality confirmation (message information normality confirmation notification) from 50% or more of the transaction confirmation units 13, the transaction issuance unit 12 determines that the normality confirmation of the message information is completed (step S16).

Next, the transaction issuance unit 12 issues the transaction (see FIG. 2) including the message information associated with the phone number and the message information confirmed notification information indicating that the normality confirmation of the message information is completed (step S17).

Proceeding to FIG. 4, the transaction issuance unit 12 passes the issued transaction to the block generation unit 14 (step S18). Here, it is previously set to transmit the transaction to the block generation unit 14 of the own operator rather than the block generation units 14 of the other operators.

When receiving the transaction from transaction issuance unit 12, the block generation unit 14 generates the block 5 including one or more transactions (FIG. 2) (step S19). This block 5 includes one or more transactions (transaction group) and a hash value (“hash value of the previous block”) calculated using all transactions (transaction group) and the hash value of the previous block (N−1) in the current block N (see FIG. 2) at present among the blocks 5 stored in the message information storage DB 100 as the blockchain 555.

When generating the newly proposed block 5 (block N+1), the block generation unit 14 outputs the block approval request including the block N+1 to the block approval unit 15 of the message information management apparatus 10 of the own operator (step S20). Then, the block generation unit 14 acquires the block approval notification indicating that the normality of the block N+1 is confirmed (approval of the block) from the block approval unit 15 (step S21). The block generation unit 14 transmits a block approval request to the block approval unit 15 of the other operator's message information management apparatus 10 (step S22). Then, the block generation unit 14 receives the block approval notification indicating the approval of the proposed block 5 from the block approval units 15 of the other operators (step S23).

Here, when receiving the approval of the block (block approval notification) from 50% or more of block approval units 15, the block generation unit 14 determines that the approval of the block is completed (step S24).

In accordance with a determination that approval of the block is completed, the block generation unit 14 writes the message information into the message information storage DB 100 of the message information management apparatus 10 of the own operator (adds the block) (step S25).

The block generation unit 14 transmits the message information writing request to the block generation units 14 of the message information management apparatuses 10 of the other operators (step S26). Then, the block generation units 14 of the other operators that receive the message information writing request writes the message information into the message information storage DB 100 (adds the block) (step S27).

As a result, a new block 5 is connected to the block N and stored as a next block (block N+1) in the blockchain 555 stored in the message information storage DB 100 of each of the message information management apparatuses 10.

Message Information Reference Processing

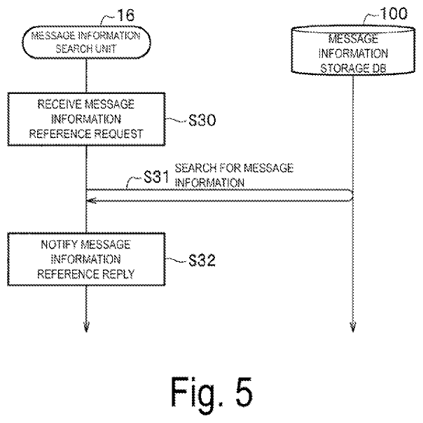

Next, a flow of the message information reference processing executed by the message information management system 1000 will be described.
FIG. 5 is a sequence diagram illustrating the flow of the message information reference processing executed by the message information management system 1000 according to the present embodiment.

First, the message information search unit 16 of the message information management apparatus 10 receives the reference request of the message information in the message board service (message information reference request) from the referring user terminal 30 (step S30).

Subsequently, the message information search unit 16 searches for the message information from the block 5 stored in the message information storage DB 100 by using the phone number added to the received message information reference request as a key (step S31).

The message information search unit 16 generates the message information reference reply with the searched message information, and notifies the message information reference reply to the referring user terminal 30 that has transmitted the message information reference request (step S32).

The message information management apparatus 10 of each operator stores the message information of all operators in the message information storage DB 100. Thus, regardless of the operator to which the user that registers the message information belongs, the referring user terminal 30 can refer to the message information by making an inquiry to the message information management apparatus 10 of any operator.

Modification Example of Present Embodiment

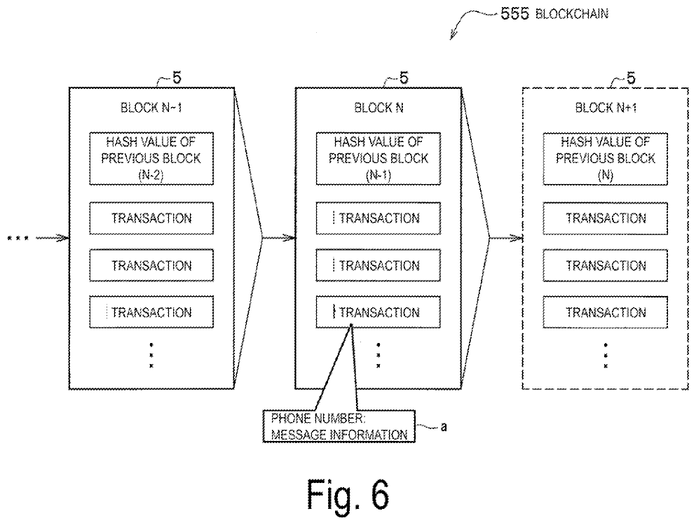

Hereinafter, a modification example of the present embodiment will be described.
In the message information registration processing, the message information management apparatus 10 according to the present embodiment determines that the normality confirmation of the message information is completed by acquiring the message information normality confirmation notification from 50% or more of the transaction confirmation units 13 including the other operators, or confirming the normality of the message information only in the transaction confirmation unit 13 of the own operator.
According to another approach, the transaction issuance unit 12 may confirm the normality of the message information only in the transaction confirmation unit 13 of the own operator and at this time, does not deem that the normality confirmation of the message information is completed. Then, at block approval of the message information management apparatuses 10 of the other operators, each of the transaction confirmation units 13 may confirm the normality of the message information.
In this case, the transaction issuance unit 12 of the own operator issues the transaction only with the message information associated with the phone number, as indicated by a reference sign a in FIG. 6. That is, as in the present embodiment (FIG. 2), the transaction does not include the “message information confirmed notification information”.

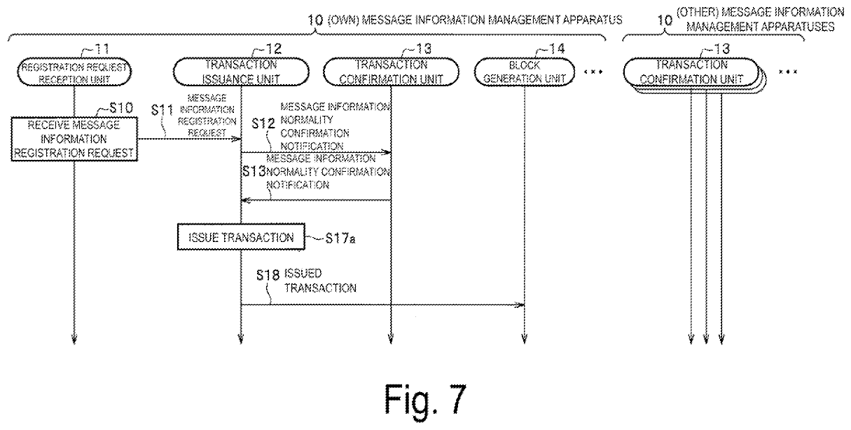

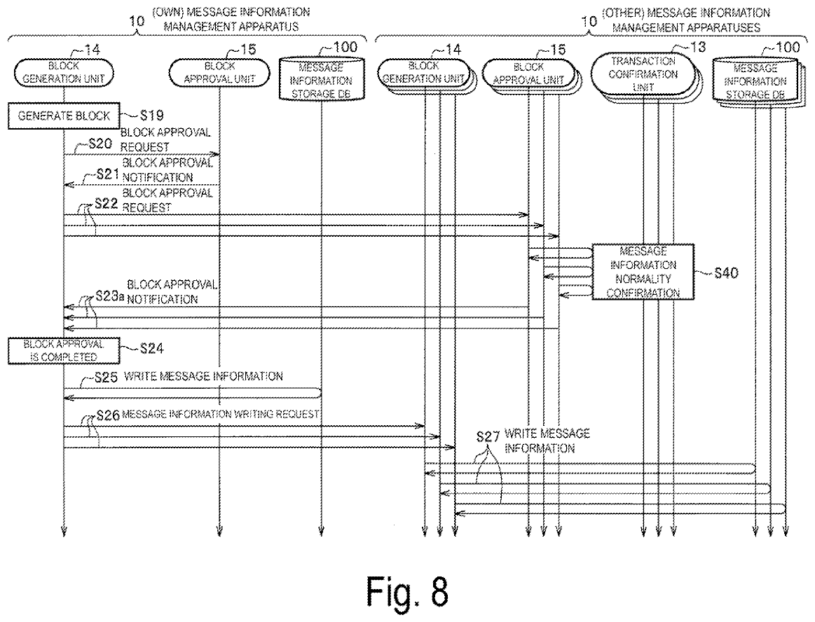

Specifically, as illustrated in FIG. 7, the transaction issuance unit 12 of the own operator acquires the message information normality confirmation notification from the transaction confirmation unit 13 of the own operator (step S13). Transaction issuance unit 12 issues a transaction about the message information (the message information associated with the phone number) (step S17a). Note that, in FIGS. 7 and 8 described later, the identical processes as the message information registration processing illustrated in FIGS. 3 and 4 in the present embodiment are given the same step numbers, and descriptions thereof will be omitted.

Then, as illustrated in FIG. 8, when the block approval units 15 of the message information management apparatuses 10 of the other operators receive the block approval request (step S22), the transaction confirmation unit 13 confirms the normality of the message information included in the transaction (step S40). When the transaction confirmation unit 13 has confirmed the normality of the message information, the block approval unit 15 confirms and approves the normality of the proposed block 5 (step S23a).

In this manner, the message information management apparatuses 10 of the other operators may confirm the normality of the message information at block approval.

As described above, according to the message information management system 1000, the message information management method, the message information management apparatus 10, and the message information management program according to the present embodiment (and the modified example of the present embodiment), the message information of all operators is stored in the message information management apparatus 10 of each operator as the blockchain. Thus, even when the operator to which the user to be referred belongs is unknown, the message information can be referred by making an inquiry to the message board service of one operator.

The message information management system 1000, the message information management method, the message information management apparatus 10, and the message information management program according to the present invention are not limited to the above-described embodiment, and can be modified without departing from the spirit of the present invention.

For example, in the present embodiment, the message information management apparatus 10 of the own operator to which the user belongs receives the message information registration request. However, the user who requests the registration of the message information may transmit the message information registration request to the message information management apparatuses 10 of the operators other than the operator to which the user belongs, and register the message information with the blockchain.
In addition, in the present embodiment, the message information registered with the disaster message board is described as text information. However, the message information is not limited to text information, and may be voice information or video information. In this case, in the normality confirmation of the message information, the transaction confirmation unit 13 confirms the normality based on the file format, the volume, and the like of voice data and video data.

### REFERENCE SIGNS LIST

1 Network
5 Block
10 Message information management apparatus (blockchain constitution apparatus)
11 Registration request reception unit
12 Transaction issuance unit
13 Transaction confirmation unit
14 Block generation unit
15 Block approval unit
16 Message information search unit
20 Registered user terminal
30 Referring user terminal
50 Blockchain system
100 Message information storage DB
555 Blockchain
1000 Message information management system

1. A message information management system comprising a plurality of message information management apparatuses configured to offer a message board service for registering and referring to message information, the plurality of message information management apparatuses being communicatively connected to each other to constitute a blockchain system, wherein
each message information management apparatus of the plurality of message information management apparatuses comprises:
a registration request reception unit configured to receive a message information registration request with the message information;
a transaction issuance unit configured to transmit a message information normality confirmation request requesting normality confirmation of the message information to a transaction confirmation unit and issue a transaction including the message information based on the normality of the message information being confirmed by acquiring a message information normality confirmation notification;
the transaction confirmation unit configured to receive the message information normality confirmation request, and based on the normality of the message information being confirmed, transmit the message information normality confirmation notification to the transaction issuance unit;
a block generation unit configured to acquire the issued transaction, generate a newly proposed block including one or more transactions, transmit a block approval request with the generated proposed block to block approval units of the message information management apparatus and other message information management apparatuses, based on normality of the proposed block being confirmed by acquiring a block approval notification, register the proposed block as a new block in a blockchain stored in a storage unit of the message information management apparatus, transmit a message information writing request to the other message information management apparatuses, and cause the other message information management apparatuses to register the proposed block as a new block in blockchains stored in storage units of the other message information management apparatuses;
the block approval unit configured to receive the block approval request, and based on the normality of the proposed block being confirmed, transmit the block approval notification to the block generation unit; and
a message information search unit configured to receive a message information reference request requesting reference to the registered message information, search each block in the blockchain stored in the storage unit of the message information management apparatus, and reply to the message information acquired by the search.

2. The message information management system according to claim 1, wherein
the transaction issuance unit is configured to issue a transaction including a message information that confirms notification information indicating that the normality of the message information is confirmed in addition to the message information, and
the block approval unit is configured to confirm that the proposed block is normal based on each of one or more transactions of the proposed block including the message information confirmed notification information.

3. A message information management method for a message information management system having a plurality of message information management apparatuses configured to offer a message board service for registering and referring to message information, the plurality of message information management apparatuses being communicatively connected to each other to constitute a blockchain system, the method comprising:
at each message information management apparatus of the message information management apparatuses:
receiving a message information registration request with the message information;
confirming normality of the message information;
issuing a transaction including the message information based on the normality of the message information being confirmed;
acquiring the issued transaction and generating a newly proposed block including one or more transactions;
transmitting a block approval request with the generated proposed block to the message information management apparatus and to the other message information management apparatuses, and confirming the normality of the proposed block by acquiring a block approval notification;
based on the normality of the proposed block being confirmed, registering the proposed block as a new block in a blockchain stored in a storage unit of the message information management apparatus, transmitting a message information writing request to the other message information management apparatuses, and causing the other message information management apparatuses to register the proposed block as a new block in blockchains stored in storage units of the other message information management apparatuses; and
receiving a message information reference request requesting reference to the registered message information, searching each block in the blockchain stored in the storage unit of the message information management apparatus, and replying to the message information acquired by the search.

4. A message information management apparatus in a message information management system comprising a plurality of message information management apparatuses configured to offer a message board service for registering and referring to message information, the plurality of message information management apparatuses being communicatively connected to each other to constitute a blockchain system, the message information management apparatus comprising:
a registration request reception unit configured to receive a message information registration request with the message information;
a transaction issuance unit configured to transmit a message information normality confirmation request requesting normality confirmation of the message information to a transaction confirmation unit and issue a transaction including the message information based on the normality of the message information being confirmed by acquiring a message information normality confirmation notification;
the transaction confirmation unit configured to receive the message information normality confirmation request, and based on the normality of the message information being confirmed, transmit the message information normality confirmation notification to the transaction issuance unit;
a block generation unit configured to acquire the issued transaction, generate a newly proposed block including one or more transactions, transmit a block approval request with the generated proposed block to block approval units of the message information management apparatus and the other message information management apparatuses, and based on normality of the proposed block being confirmed by acquiring a block approval notification, register the proposed block as a new block in a blockchain stored in a storage unit of the message information management apparatus, transmit a message information writing request to the other message information management apparatuses, and cause the other message information management apparatuses to register the proposed block as a new block in blockchains stored in storage units of the other message information management apparatuses;
the block approval unit configured to receive the block approval request, and based on the normality of the proposed block being confirmed, transmit the block approval notification to the block generation unit; and
a message information search unit configured to receive a message information reference request requesting reference to the registered message information, search each block in the blockchain stored in the storage unit of the message information management apparatus, and reply to the message information acquired by the search.

5. (canceled)
